(19) United States
(12) Patent Application Publication
(10) Pub. No.: US 2010/0194729 A1
(43) Pub. Date: Aug. 5, 2010

(54) DRIVING CIRCUIT OF PLASMA DISPLAY PANEL AND DRIVING METHOD THEREOF

(75) Inventors: Yong Duk Kim, Gyeongsangbuk-do (KR); Young Jun Lee, Gyeongsangbuk-do (KR); Su Sam Choi, Gyeongsangbuk-do (KR)

Correspondence Address: HEAD, JOHNSON & KACHIGIAN, 228 W 17TH PLACE, TULSA, OK, 74119, US

(73) Assignee: Orion PDP Co., Ltd.

(21) Appl. No.: 12/733,717

(22) PCT Filed: Sep. 19, 2008
(86) PCT No.: PCT/KR2008/005560

§ 371 Date: Mar. 16, 2010

(30) Foreign Application Priority Data
Sep. 20, 2007 (KR) 10-2007-0095785

(51) Int. Cl. G06F 3/038

(52) U.S. Cl. 345/209

(57) ABSTRACT

Disclosed are a driving circuit of a plasma display panel (PDP) driving circuit and a driving method thereof, which can simplify the driving circuit and stably secure a sustain discharge waveform. The PDP includes a first electrode applying a ramp-up voltage, a ramp-down voltage, a scan pulse voltage and a sustain discharge voltage; a second electrode applying a ground voltage GND and a level voltage of a second electrode; and a third electrode applying a data voltage for selecting discharge cells in an address period. In the driving method using a driving waveform divided into a reset period, an address period and a sustain period, positive and negative sustain discharge voltages are alternately applied to the first electrode and the ground voltage GND is applied to the second electrode in the sustain period.

### TECHNICAL FIELD

Embodiments of the present invention relate to a driving circuit of a plasma display panel (PDP) and a driving method thereof, more particularly to a driving circuit of a PDP and a driving method thereof, which can ensure simplification of the driving circuit and a stable sustain discharge waveform.

### BACKGROUND ART

An alternating current plasma display panel (AC-PDP) has a structure including three electrodes, i.e., a scan electrode Y, a sustain electrode X and an address electrode A, and controls brightness by inducing stable discharge of cell using voltages applied to the respective electrodes. Such an AC-PDP is time-divisionally driven by dividing one frame into several subfields having different light-emitting times so as to realize a gray scale of an image.

Each of the subfields is divided into three periods, i.e., a reset period, an address period and a sustain period. The reset period is a period for controlling the state of a uniform wall charge suitable for discharge conditions of all cells in the panel to be maintained with respect to a voltage applied from the outside of the panel so as to induce stable address discharge in the address period. The address period is a period for selecting cells to be discharged and cells not to be discharged in the sustain period by sequentially applying a scan pulse to all scan electrodes and simultaneously applying a data pulse of a data voltage V_{d} to address electrodes. At this time, the discharge cells experience a large change in wall charge, and the discharge condition is formed so that sustain discharge can be sustained in the sustain period. The sustain period is a period for allowing the sustain discharge to be sustained in only the cells selected as discharge cells in the address period by alternately applying a high sustain discharge voltage Vₛᵤₛ between the scan and sustain electrodes.

Meanwhile, as shown in FIG. 1, a reset driving waveform having a ramp shape is generally used as a driving waveform of the AC-PDP. The ramp reset waveform has an advantage in that the wall charge is uniform in the reset period, and the luminance of background light is not high. A ramp voltage Vᵣₐₘₚ is a final voltage of the ramp reset waveform, and may be changed in the subfields considering a high contrast ratio. In general, the ramp voltage Vᵣₐₘₚ decreases with time.

A PDP driving circuit that realizes the driving waveform of FIG. 1 is configured as shown in FIG. 2. The PDP driving circuit of FIG. 2 will be described in detail. As shown in FIG. 2, the PDP driving circuit has a scan electrode (Y) board and a sustain electrode (X) board, and a panel CP is connected between the two boards. The Y-board includes a sustain discharge voltage supply circuit having control switches SW3 and SW4; an energy recovery circuit having control switches SW1 and SW2, reverse voltage limiting diodes D1 and D2, a capacitor CRY for energy recovery, and an auxiliary inductor LRY so as to recover energy supplied to the panel CP; a ramp-up control circuit having control switches SW5 and SW7, and a capacitor C1 so as to output a ramp-up waveform having a slope; a ramp-down control circuit having control switches SW6, SW8 and SW9 so as to output a ramp-down waveform having a slope; a level voltage supply circuit having control switches SW10 and SW11 so as to generate a level voltage V_{yl} of an Y-electrode in an address period; and a scan device Scan-IC having control switches SW12 and SW13. Since driving waveform of the X-board is simpler than that of the Y-board, the configuration of X-board is also simpler than the Y-board. The X-board includes a circuit (SW16 and SW17) for supplying a sustain driving voltage; an energy recovery circuit (SW14, SW15, D4, D5, CRX and LRX) for improving discharge energy efficiency; and an X-level voltage control circuit (SW18 and SW19) for supplying an X-level voltage Vₓₗ in an address period.

As described above, the conventional PDP driving circuit has a very complicated configuration, including a plurality of control switches. Therefore, it requires high manufacturing cost.

### DISCLOSURE OF INVENTION

### Technical Problem

Therefore, the present invention has been made in view of the above problems, and provides a driving circuit of a PDP, which can ensure simplification of the driving circuit and a stable sustain discharge waveform.

### Technical Solution

In an aspect, the present invention provides a driving method of a plasma display panel (PDP) including a first electrode applying a ramp-up voltage, a ramp-down voltage, a scan pulse voltage, level voltage and a sustain discharge voltage; a second electrode; and a third electrode applying a data voltage for selecting discharge cells in an address period, the driving method using a driving waveform divided into a reset period, an address period and a sustain period, wherein, in the sustain period, positive and negative sustain discharge voltages are alternately applied to the first electrode and a ground voltage GND is applied to the second electrode.

In the reset period of the driving waveform, the maximum amplitude of the ramp voltage applied to the first electrode in the ramp-up period may be set differently for each subfield. The maximum amplitude of a ramp voltage of the first electrode in a ramp-up period is identical to or smaller than the sum of the positive sustain discharge voltage and the level voltage of the first electrode

In the ramp-up period, the voltage applied to the first electrode may not contain a level voltage component but may contain only a waveform with a slope using the positive sustain discharge voltage. Before the ramp-up period starts, a negative sustain discharge voltage may be applied to the first electrode.

In the ramp-up period, the ramp voltage rising with a slope applied to the first electrode may have two different slopes. Generally, a first slope may be steeper than a second slope. Alternatively, the second slope may be steeper than the first slope.

A voltage V_{yd} at the end time of the reset period may be identical to or higher than the negative sustain discharge voltage −Vₛᵤₛ. In a ramp-down period of the reset period, the ramp voltage falling with a slope may have two different slopes. Generally, a first slope may be steeper than a second slope.

The absolute values of the positive and negative sustain discharge voltages applied to the first electrode may be identical to each other. Alternatively, the absolute values of the positive and negative sustain discharge voltages applied to the first electrode may be different from each other.

In the ramp-down period, a level voltage may be applied to the second electrode. In some cases, the level voltage may be 0 V. As occasion demands, the level voltage applied to the second electrode may be a ground voltage GND (0 V) in the address period.

In accordance with another aspect of the present invention, there is provided a PDP driving circuit controlling a driving waveform divided into a reset period, an address period and a sustain period, the driving circuit controlling a ramp-up voltage, a ramp-down voltage, a scan pulse and a sustain discharge voltage applied to a first electrode; a level voltage applied to a second electrode; and a data voltage applied to a third electrode, wherein the driving circuit has a combination of a first electrode board controlling the voltage applied to the first electrode and a second electrode board controlling the voltage applied to the second electrode, and the first electrode board includes: a control switch SW3 supplying a positive sustain discharge voltage +Vₛᵤₛ; a control switch SW4 supplying a negative sustain discharge voltage −Vₛᵤₛ; a control switch SW5 connected to the positive sustain discharge voltage to generate a ramp-up waveform rising with a slope; and a control switch SW6 connected to the negative sustain discharge voltage to generate a ramp-down waveform falling with a slope.

The first electrode board may further include a control switch device for energy recovery having first and second control switches SW1 and SW2; and a capacitor CR storing energy recovered by the first and second control switches. A negative terminal of the capacitor CR storing the recovered energy may be connected to the negative sustain discharge voltage −Vₛᵤₛ, or a positive terminal of the capacitor CR may be connected to the ground voltage GND of 0 V.

The first electrode board may further include a scan device having control switches SW9 and SW10, and a positive terminal of the control switch SW9 may be connected to a level voltage V_{yl} of the first electrode. Alternatively, a positive terminal of the level voltage V_{yl} may be connected to a diode D3 restricting reverse current and a capacitor C1 stabilizing the level voltage V_{yl}, and a negative terminal of the level voltage V_{yl} may be connected to the negative sustain discharge voltage −Vₛᵤₛ.

The second electrode board may include a control switch SW7 applying a level voltage Vₓₗ to the second electrode; and a control switch SW8 applying a ground voltage. Particularly, when the level voltage Vₓₗ of the second electrode is 0 V, the second electrode of the PDP may be directly connected to the ground voltage GND. In this case, no control switch may be used in the second electrode board.

Although it has been described in the driving waveform and the driving circuit that a voltage of 0 V is not used in the first electrode, the voltage of 0 V may be used. In this case, the voltage of 0 V may be applied to the first electrode in a period preceding the ramp-up period, a period preceding the sustain period, or the like. The PDP driving circuit may further include a control switch SW11 applying a voltage of 0 V and a diode D4 connected in series to the control switch SW11, and the diode D4 may be connected to the ground voltage. Alternatively, the PDP driving circuit may further include control switches SW12 and SW13 connected in series, and the control switch SW12 may be connected to the ground voltage.

### Advantageous Effects

A PDP driving circuit and a driving method thereof according to the present invention have advantages as follows.

The PDP driving circuit according to the present invention has a simpler circuit configuration than the conventional PDP driving circuit. In the PDP driving circuit according to the present invention, a sustain discharge voltage can be more stably supplied to a panel than in the conventional PDP driving circuit. In the conventional PDP driving circuit of FIG. 2, two control switches SW5 and SW6 are used while the sustain discharge voltage is applied to scan electrodes. However, in the present invention, the corresponding control switches are not required. Therefore, the entire power consumption and heat generation of the driving circuit can be decreased, and the sustain discharge voltage can be stably supplied to the panel. Further, since a DC/DC circuit generating a scan voltage −V_{sc} is not required, cost of manufacturing the driving circuit can be saved.

### BRIEF DESCRIPTION OF THE DRAWINGS

FIG. 1 is a waveform diagram showing a PDP driving waveform according to a related art.

FIG. 2 is a circuit diagram of a PDP driving circuit according to the related art.

FIG. 3 is a waveform diagram showing a PDP driving waveform according to an embodiment of the present invention.

FIG. 4 is a waveform diagram showing a PDP driving waveform according to another embodiment of the present invention.

FIG. 5 is a waveform diagram showing a PDP driving waveform according to another embodiment of the present invention.

FIG. 6 is a circuit diagram of a PDP driving circuit for realizing the PDP driving waveforms according to the embodiments of the present invention.

FIG. 7 is another circuit diagram of the PDP driving circuit for realizing the PDP driving waveforms according to the embodiments of the present invention.

FIG. 8 is still another circuit diagram of the PDP driving circuit for realizing the PDP driving waveforms according to the embodiments of the present invention.

FIG. 9 is a timing diagram showing on/off states of control switches SW1 to SW10 of FIG. 6 to realize the driving waveform of FIG. 3.

FIGS. 10 to 14 are circuit diagrams showing current flows corresponding to respective periods of T₁ to T₄ in the driving circuit of FIG. 6.

FIG. 15 is a waveform diagram showing a PDP driving waveform according to another embodiment of the present invention.

FIG. 16 is a circuit diagram of a PDP driving circuit realizing the driving waveform of FIG. 15 according to another embodiment of the present invention.

FIG. 17 is a circuit diagram of another circuit applying a voltage GND to a first electrode board of FIG. 16.

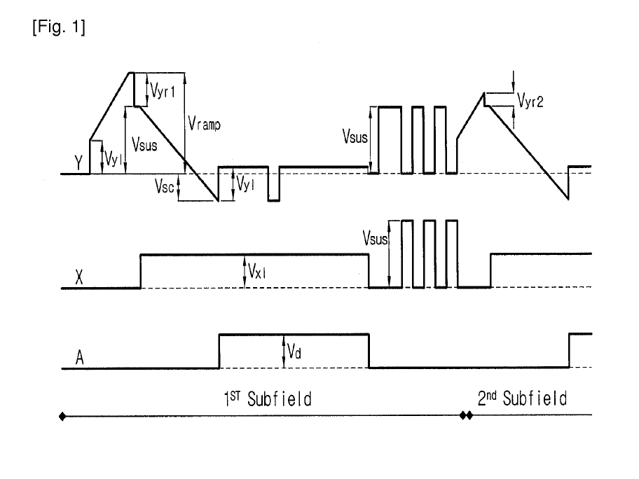

### MODE FOR THE INVENTION

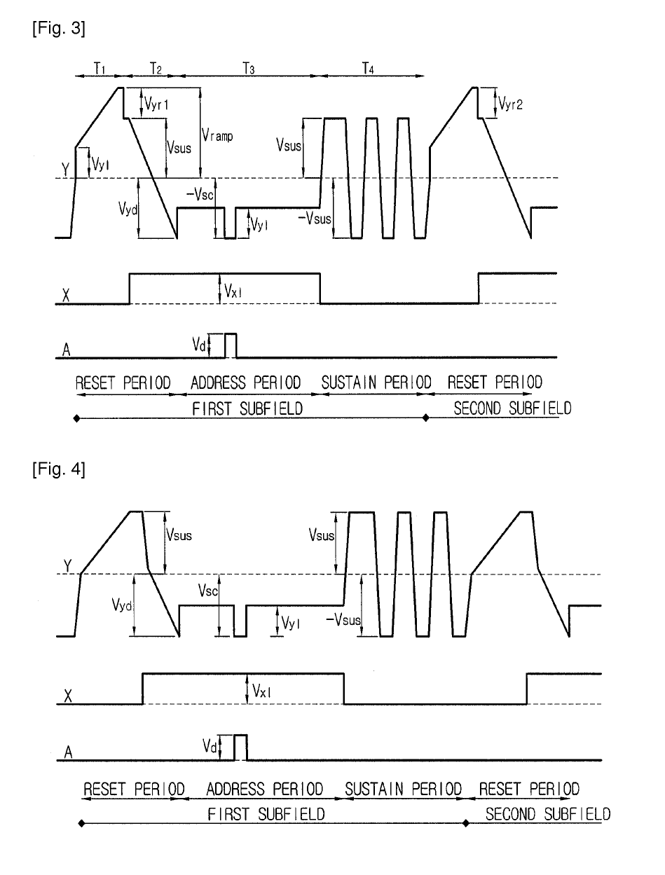

Hereinafter, a driving circuit of a plasma display panel (PDP) and a driving method thereof according to embodiments of the present invention will be described in detail with reference to the accompanying drawings. FIG. 3 is a waveform diagram showing a PDP driving waveform according to an embodiment of the present invention.

First of all, the PDP driving waveform shown in FIG. 3 will be described. A voltage waveform applied to a first electrode (scan electrode) has a sustain discharge waveform in which positive and negative sustain discharge voltages +Vₛᵤₛ and −Vₛᵤₛ are alternately and repeatedly applied. A voltage V_{sc} has an amplitude equal to that of the negative sustain discharge voltage −Vₛᵤₛ. Here, the voltage V_{sc} is a voltage at the time when a scan pulse is applied during an address period, and a voltage inputted to a terminal to which a negative voltage is applied in a high-voltage input unit of a scan device. In a voltage applied to a second electrode (sustain electrode), a level voltage Vₓₗ is applied only in the address period, and a ground state GND is always maintained in the other periods.

The PDP driving waveforms of FIG. 3 will be time-serially described as divided into periods T₁, T₂, T₃ and T₄.

First, the period T₁ corresponds to a ramp-up period of a reset period. A ramp-up process functions to reduce a difference of wall charges between discharge and non-discharge cells in a previous subfield. In case of a discharge cell, due to sustain discharge, negative (−) charges are accumulated on the cell wall positioned at a second electrode of the discharge cell, and positive (+) charges are accumulated on the cell wall positioned at a first electrode of the discharge cell. The discharge cell is in the state that the sustain discharge can be operated when a sustain discharge voltage is applied. On the other hand, in case of a non-discharge cell, the state of wall charges that have been formed during a ramp-down period of a reset period in the previous subfield is still maintained at cell walls respectively positioned at first and second electrodes of the non-discharge cell. That is, at the final time of the previous subfield or the start time of a current subfield, the state of wall charges in the discharge cell selected to operate the sustain discharge is different from that of wall charges in the non-discharge cell that was not selected. For this reason, it is required to readjust the states of wall charges to be uniform. In each of the cells that were discharge cells in the previous subfield, positive (+) charges are accumulated on a dielectric positioned at a first electrode and negative (−) charges are accumulated on a dielectric positioned at a second electrode by a negative sustain discharge voltage pulse which is a sustain discharge voltage pulse for final discharge. Here, instead of a positive square type sustain discharge voltage pulse, a ramp-up type reset driving wave is applied to generate a weak discharge, thereby preventing a rapid change in wall charge. In the case of the non-discharge cell, although a weak discharge is not generated even though a voltage increases up to a positive sustain discharge voltage Vₛᵤₛ. However, if a voltage higher than the positive sustain discharge voltage is applied to the non-discharge cell, a weak discharge is generated alike the discharge cell which was discharged in the previous subfield. The weak discharge is generated by applying a high ramp voltage in the initial subfield of subfields for displaying an image.

In a subsequent subfield, the high ramp voltage used in the first subfield is not used, but a ramp voltage lower than the high ramp voltage is usually used to decrease background light luminance. The state of wall charges in the non-discharge cells is the same as that at the end time of the period T₂ in which the reset is finished. For this reason, in case of some subfields, the maximum ramp-up voltage may be smaller than that in the first subfield, or the period T₁, in which a ramp-up type reset driving waveform is applied, may not be included, if required so. Further, a level voltage V_{yl} of the first electrode may not be used in the ramp-up period. FIG. 4 is a waveform diagram showing a PDP driving waveform in which the level voltage V_{yl} is not used in the ramp-up period according to another embodiment of the present invention.

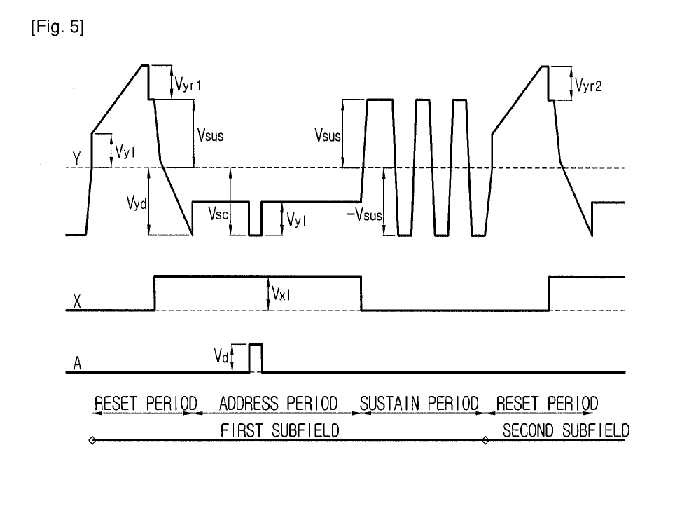

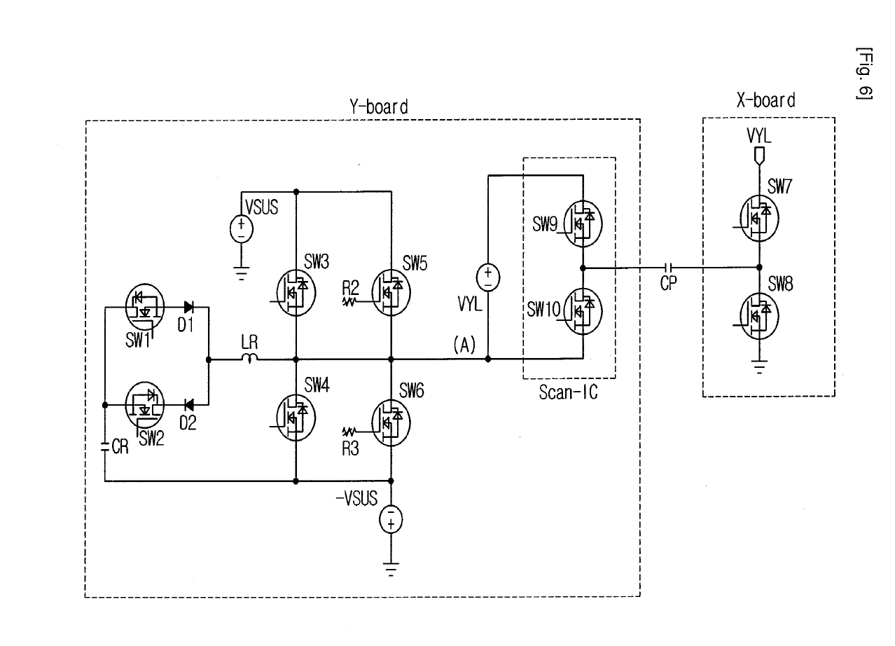

At the end time of the period T₁, the state of wall charges in the discharge cell is not completely identical to that of wall charges in the non-discharge cell. However, the state of wall charges in the discharge cell becomes identical to that of wall charges in the non-discharge cell because of the period T₂ which is a ramp-down period. The ramp-down period is a period in which the voltage of the first electrode decreases down to a voltage V_{yd}. Here, the voltage may be decreased to have two slopes when the voltage decreases down to the voltage V_{yd} as shown in FIGS. 4 and 5. FIG. 5 is a waveform diagram showing a PDP driving waveform according to another embodiment of the present invention. In a first period, the voltage is decreased fast with a relatively greater slope so that discharge is not generated. In a second period, the voltage is decreased gradually with a relatively smaller slope while a weak discharge is generated. If the voltage with the two slopes is decreased down to the voltage V_{yd}, an erroneous discharge is not generated, and the output voltage of the first electrode decreases rapidly, thereby saving a driving time. Here, the voltage V_{yd} is set to be identical to or higher than the scan voltage V_{sc} applied in the address period to a negative terminal of the two high-voltage terminals of the scan device. At this time, a level voltage Vₓₗ of the second electrode is applied to the second electrode. The level voltage of the second electrode may not be used during the period T₂ depending on driving characteristics of the PDP. That is, a ground voltage GND of 0 V may be applied to the second electrode.

In the period T₂, the cells that were discharge cells in the previous subfield have more wall charges than those of the non-discharge cells during the reset period having the ramp-up type reset driving waveform. For this reason, a relatively large number of weak discharges are generated. Accordingly, the sate of wall charges in the discharge cells is identical to that of wall charges in the non-discharge cells, and the reset discharge process is finished. Then, it is ready to start an address discharge.

After the reset periods T₁ and T₂ are finished, the address period T₃ starts. In the period T₃, a scan pulse is sequentially applied to respective scan lines of first electrodes that are scan electrodes. First, the level voltage V_{yl} of the first electrodes is applied to all the first electrodes based on the voltage V_{sc}. Here, the level voltage V_{yl} is applied to the positive high-voltage input terminal of the scan device, and the voltage V_{sc} is applied to the negative high-voltage input terminal of the scan device. While the voltage V_{yl} is connected as an output of each of the scan lines and applied to cells, the voltage V_{sc} is sequentially connected as an output of each of the scan lines, so that the respective scan lines are sequentially selected. Simultaneously, address discharge is generated by applying a data voltage V_{d} to a third electrode that is an address electrode A. At this time, the data voltage is controlled to be applied only to data lines of cells to be discharged in all the cells of the selected scan lines. In a cell in which the address discharge is generated, positive (+) charges are accumulated on the wall of the first electrode in the cell, and negative (−) charges are accumulated on the wall of the second electrode in the cell. Like in the period T₂, the level voltage of the second electrode may be set as 0 V in the period T₃, depending on the state of the PDP.

In the cells selected as discharge cells through the address discharge, a continuous sustain discharge is generated as a sustain discharge voltage is applied in the period T₄. The continuous sustain discharge is generated by alternately applying positive and negative sustain discharge voltage +Vₛᵤₛ and −Vₛᵤₛ to a Y electrode. On the other hand, in the non-discharge cell, wall charges are not accumulated sufficiently to induce discharge with the sustain discharge voltage only. For this reason, discharge is not generated there. The number of pulses of the sustain discharge is controlled to express luminance, and may be varied depending on the subfields.

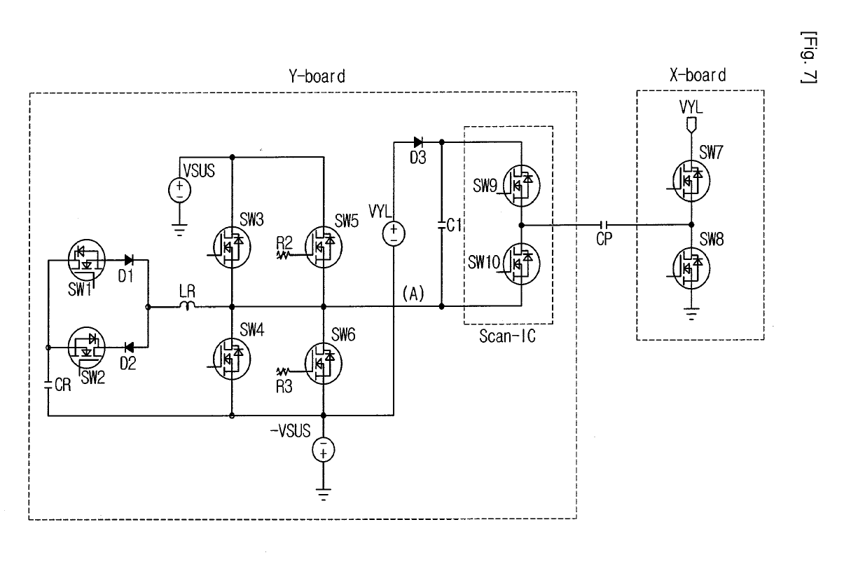

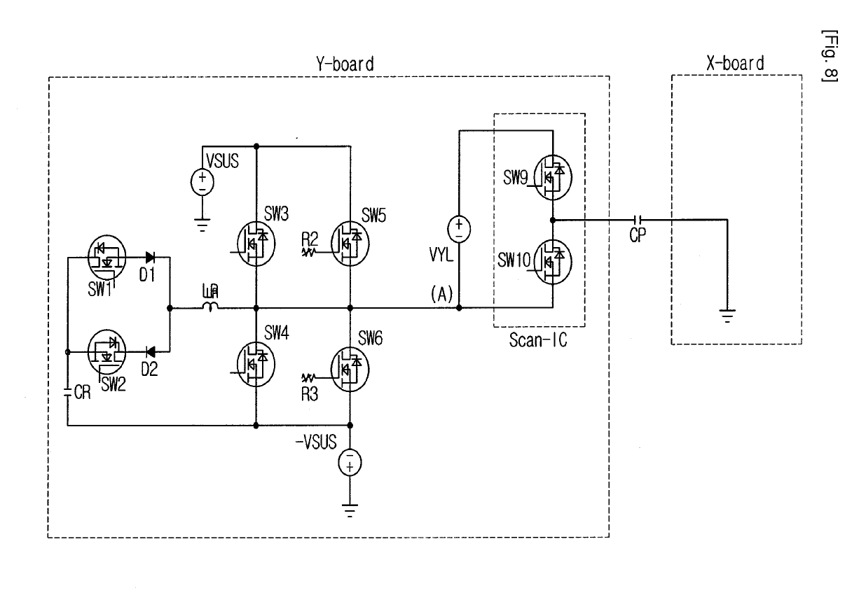

PDP driving waveforms according to the embodiments of the present invention have been described. Hereinafter, a PDP driving circuit for realizing the PDP driving waveforms according the embodiments of the present invention will be described. FIG. 6 is a circuit diagram of a PDP driving circuit for realizing the PDP driving waveforms according to example embodiments of the present invention. FIGS. 7 and 8 are other circuit diagrams of the PDP driving circuit for realizing the PDP driving waveforms according to the embodiments of the present invention.

As shown in FIG. 6, the PDP driving circuit according to an embodiment of the present invention consists of a combination of first and second electrode boards. The first electrode board includes control switches SW1 to SW6 and a scan device, and the second electrode board includes control switches SW7 and SW8. The control switches constituting the first and second electrode boards will be described as follows.

In the first electrode board, the control switches SW1 and SW2 are control devices for energy recovery, and a capacitor CR connected between the control switches SW1 and SW2 is a capacitor for energy recovery, in which recovered energy is charged. A negative terminal of the capacitor CR for energy recovery is connected to a negative sustain discharge voltage source. In some cases, the capacitor for energy recovery may not be used, but a middle node connected between a drain terminal of the first control switch SW1 and a source terminal of the second control switch SW2 may be connected to a ground GND. The control switch SW3 supplies a positive sustain discharge voltage +Vₛᵤₛ to the panel and is connected to the positive sustain discharge voltage +Vₛᵤₛ. The control switch SW4 supplies the negative sustain discharge voltage −Vₛᵤₛ to the panel and is connected to the negative sustain discharge voltage −Vₛᵤₛ. The control switch SW5 is used to generate a ramp-up waveform that rises with a predetermined slope. The control switch is connected to the positive sustain discharge voltage +Vₛᵤₛ and is designed to supply a voltage as high as the positive sustain discharge voltage +Vₛᵤₛ. The control switch SW6 is used to generate a ramp-down waveform that falls with a predetermined slope, and connected to the negative sustain discharge voltage −Vₛᵤₛ. The control switch SW4 applying the negative sustain discharge voltage −Vₛᵤₛ is commonly used as a control switch that supplies a negative high voltage to the scan device in an address period.

Meanwhile, the driving circuit is designed so that the level voltage V_{yl} of a first electrode has a predetermined voltage level based on a negative high-voltage input terminal of the scan device and is applied to a positive high-voltage input terminal of the scan device. As shown in FIG. 7, a negative terminal of the level voltage of the first electrode may be connected to the negative sustain discharge voltage −Vₛᵤₛ. In this case, a positive terminal of the level voltage of the first electrode is not directly connected to the positive high-voltage input terminal of the scan device but an additional circuit having a diode D3 and a capacitor C1 is added. The reason why the diode D3 and the capacitor C1 are added is to charge the level voltage V_{yl} into the capacitor C1 via the diode D3 at the time when the voltage is applied to a node (A) of FIG. 6 becomes the negative sustain discharge voltage −Vₛᵤₛ, and to prevent the diode D3 is from being in a reverse bias state so that a transient voltage flows toward the level voltage V_{yl} in other cases. The scan device is simply depicted as switches SW9 and SW10.

The second electrode board includes control switches SW7 and SW8. Here, the control switch SW7 applies the level voltage Vₓₗ of a second electrode to the second electrode board, and the control switch SW8 applies a ground voltage GND of 0 V to the second electrode board. In some cases, the level voltage Vₓₗ of the voltages applied to the second electrode board may be applied as 0 V throughout the entire region. In this case, the control switches SW7 and SW8 may be omitted as shown in FIG. 8.

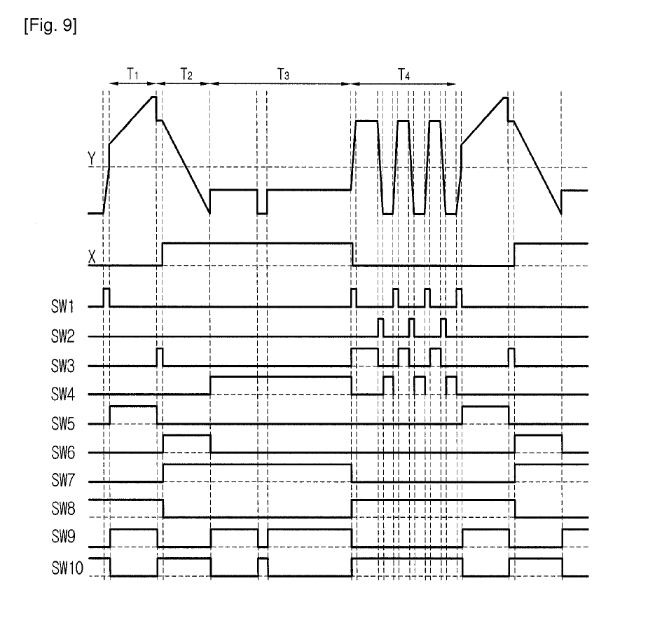

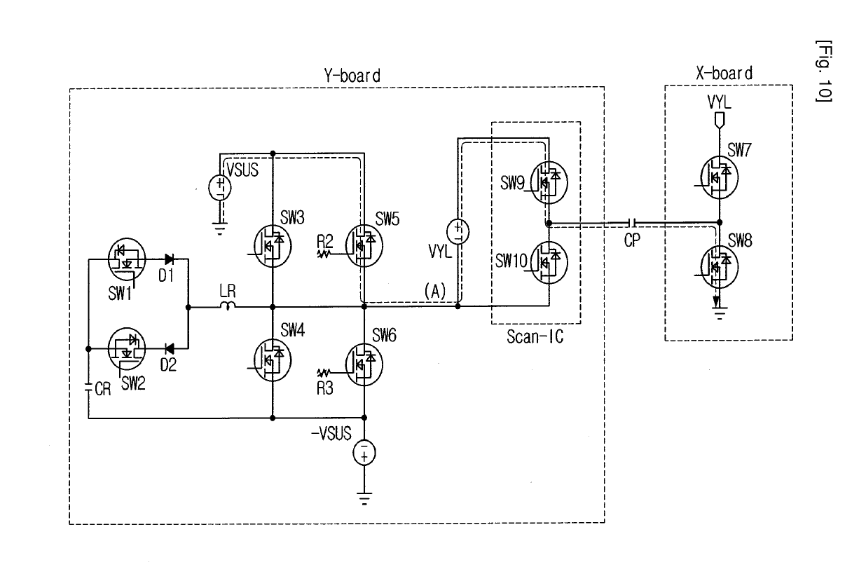

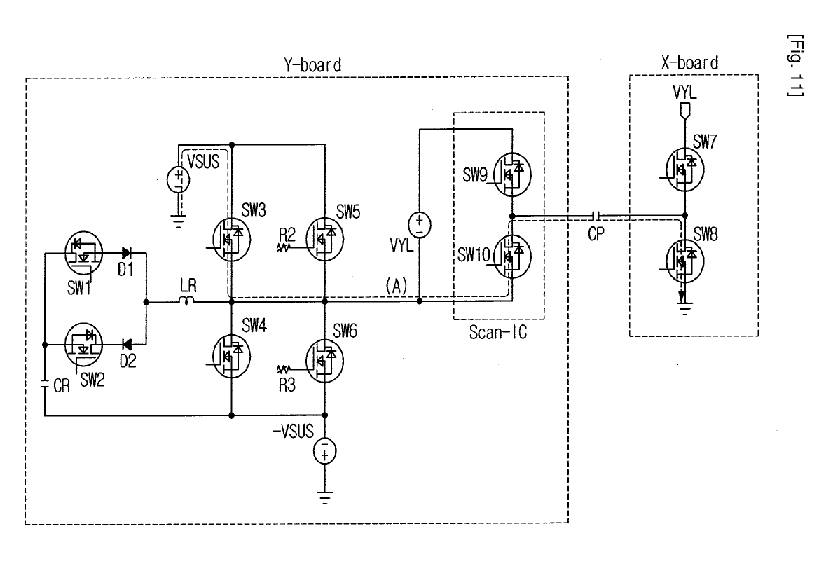

Hereinafter, the operation of the PDP driving circuit configured as described above will be described with reference to a timing diagram. FIG. 9 is a timing diagram showing on/off states of SW1 to SW10 of FIG. 6 to implement the driving waveforms of FIG. 3. FIGS. 10 to 14 are circuit diagrams showing current flows corresponding to respective periods of T₁ to T₄ in the driving circuit of FIG. 6.

As shown in FIGS. 3 and 9, the PDP driving waveforms are time-serially divided into periods T₁ to T₄. The operation of the PDP driving circuit of FIG. 6 for each of the periods will be described as follows.

First, the period T₁ is shown in FIG. 10. Specifically, the operation of generating a slope in a ramp-up period will be described. In the first electrode board, the control switch SW5 for the ramp-up waveform is on, and the control switch SW9 of the scan device for applying the level voltage V_{yl} of the first electrode is on so as to form a higher ramp voltage than the sustain discharge voltage Vₛᵤₛ. Simultaneously, in the second electrode board, the control switch SW8 is on. The other control switches are off. As such, the voltage at the node (A) of the first electrode board becomes a ramp waveform gradually rising depending on the amplitude of a gate voltage applied to the control switch SW5, and the final output voltage of the first electrode board becomes the sum of the voltage at the node (A) and the level voltage V_{yl} of the first electrode. Therefore, the initial output voltage in the period T₁ is V_{yl} and gradually increases, so that the final amplitude of the ramp voltage Vᵣₐₘₚ in the ramp-up period becomes the sum of V_{yl} and Vₛᵤₛ. Here, the ramp voltage Vᵣₐₘₚ may be set to be lower than the sum of V_{yl} and Vₛᵤₛ, in some cases. The voltage Vᵣₐₘₚ may be set to be lower than the sum of V_{yl} and Vₛᵤₛ by allowing the control switch SW5 to be off before the ramp voltage controlled by the control switch SW5 in the ramp-up period reaches the sustain discharge voltage Vₛᵤₛ. Such an operational control may be determined considering electrical discharge characteristics of the panel. The operational control lowers luminance of background light, thereby improving a contrast ratio. When the level voltage V_{yl} of the first electrode is not applied in the ramp-up period as shown in FIG. 4, the control switch SW9 of the scan device is not on, but the control switch SW10 is on.

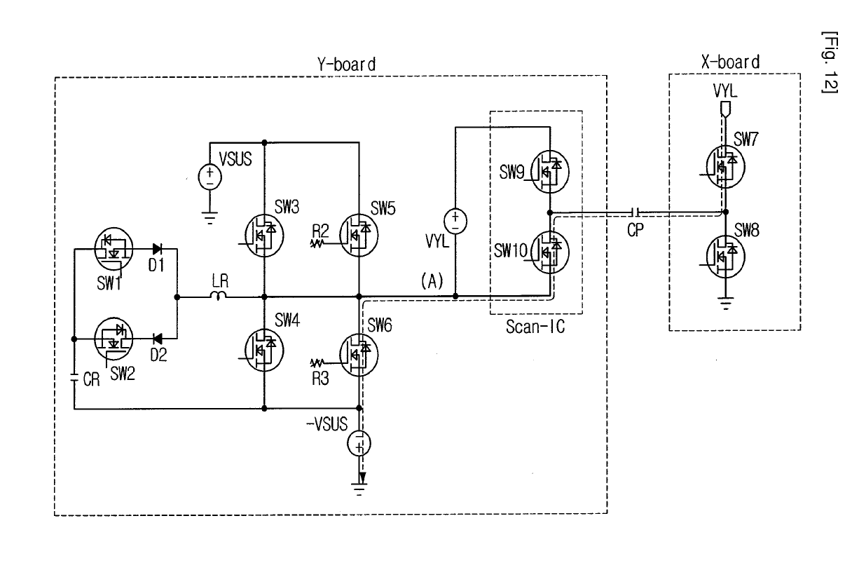

In the period T₂, the rising output voltage of the first electrode falls down to the voltage V_{yd}, and uniformity of wall charges can be stably achieved without causing any strong discharge. To this end, the ramp voltage Vᵣₐₘₚ that rises above than the positive sustain discharge voltage is decreased down to the positive sustain discharge voltage. In the first electrode board, while the control switch SW9 of the scan device is off, the control switch SW10 of the scan device is on, and the control switch SW3 supplying the positive sustain discharge voltage Vₛᵤₛ is on. In the second electrode board, the control switch SW8 remains in an on state. As shown in FIG. 11, in the first electrode board, current flows into the panel CP through a route Vₛᵤₛ-SW3-SW10, and in the second electrode board, the current flows through the control switch SW8.

Thereafter, in a ramp-down period, a control switch operation is performed, in which the rising output voltage of the first electrode falls with a slope down to the voltage V_{yd} that is the final voltage of the ramp-down waveform. Specifically, in the first electrode board, the control switch generating a slope of the ramp-down waveform is on. In the second electrode board, the control switch SW7 is on and the control switch SW8 is off so as to apply the level voltage Vₓₗ of the second electrode. Here, the level voltage Vₓₗ of the second electrode may be applied from the period T₃ that is an address period. In this case, a control switch conversion operation is not performed in the second electrode board. As the output voltage of the first electrode board decreases continuously with a slope, it may decrease to have two slopes like in the PDP driving waveforms shown in FIGS. 4 and 5. In order to attain the two slopes of FIGS. 4 and 5, a plurality of control switch circuits adjustable to provide different slopes may be used, or one switch may be controlled using two control signals.

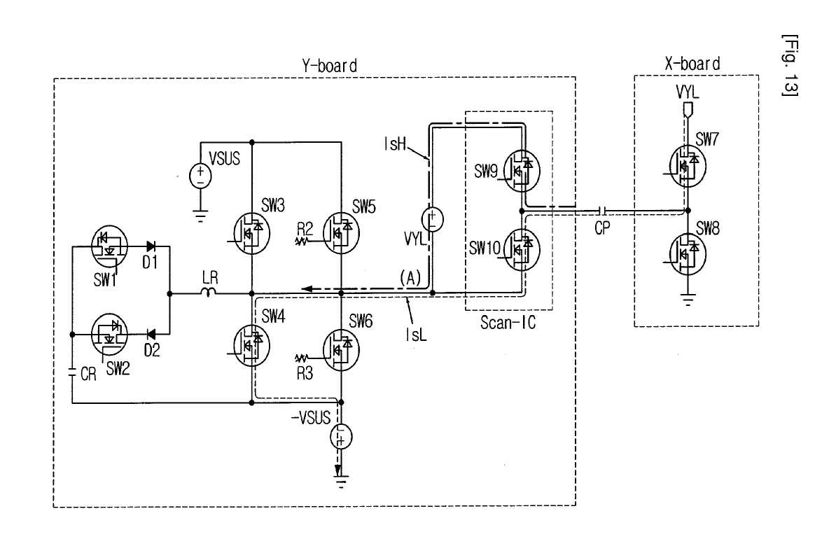

As shown in FIG. 12, in the first electrode board, current in the period T₂ flows from the panel CP to the negative sustain discharge voltage −Vₛᵤₛ through the control switch SW10 and the control switch SW6, and in the second electrode board, the current flows into the panel CP through the level voltage Vₓₗ of the second electrode and the control switch SW9. Here, the current flows through the control switch SW9 when a ground state GND is maintained in the first electrode. The voltage V_{yd} at the reset end time of the output voltage of the second electrode board may be set to be identical to or higher than the voltage −V_{sc}. For reference, a voltage identical to the voltage −Vₛᵤₛ is used as the voltage −V_{sc}.

Subsequently, the period T₃ is a period in which address discharge is induced to distinguish discharge cells from non-discharge cells. In the period T₃, two voltages are applied each of the scan electrodes through the scan device of the first electrode board. The scan device has the same number of control switches SW9 and SW10 as the number of scan lines. For reference, only a pair of control switches SW9 and SW10 are shown in the drawings of the present invention, for the convenience of simplicity.

The operation of the PDP driving circuit in the period T₃ will be described. A voltage −V_{sc} is applied to the negative high-voltage input terminal of the scan device. Here, the voltage −V_{sc} is a voltage identical to the negative sustain discharge voltage −Vₛᵤₛ. Simultaneously, a voltage V_{yl}-V_{sc} higher by the voltage V_{yl} than the voltage −V_{sc} is applied to the positive high-voltage input terminal. In this case, the control switch SW4 remains in an on state, and the control switches SW9 and SW10 of the scan device apply a scan pulse by operating in such a manner that the control switch SW10 is sequentially on for each of the scan lines. Here, the level voltage V_{yl} of the first electrode board is not greater than the maximum allowance voltage applied to the scan device. As a corresponding scan line is selected while the voltage V_{yl-V}_{sc} is applied to each of the scan electrodes by allowing the control switches SW9 and SW10 to be on and off, respectively, the control switch W9 is off and the control switch SW10 is on only in the corresponding scan line. Accordingly, the voltage −V_{sc} is applied as the scan pulse. At this time, in the second electrode board, the control switch SW8 is off and the control switch SW7 is on so as to apply the level voltage Vₓₗ of the second electrode.

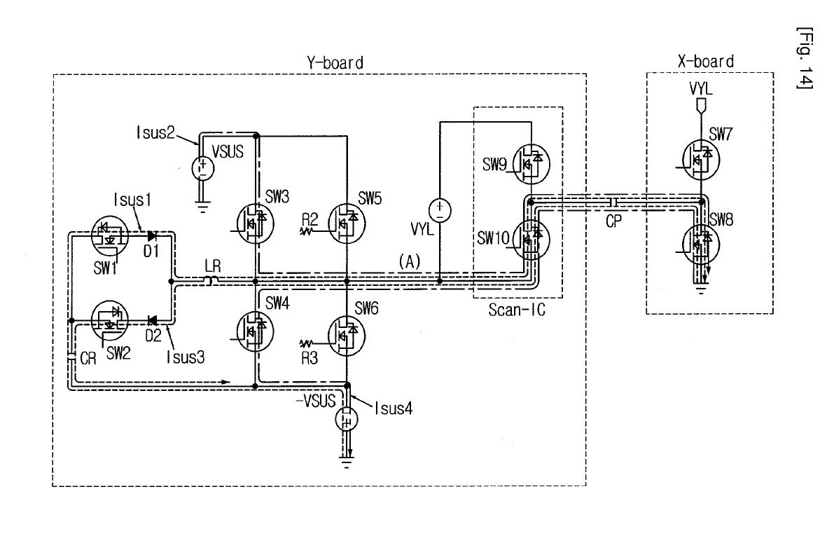

Current flow in the period T₃ will be described with reference to FIG. 13. When the control switch SW9 is on and the control switch SW10 is off in the first electrode board, current I_{sH} flows from the panel CP to the negative sustain discharge voltage −Vₛᵤₛ through the control switch SW9, the level voltage V_{yl} of the first electrode and the control switch SW4. When the control switch SW9 is off and the control switch SW10 is on, current I_{sL} of the scan line flows from the panel CP to the negative sustain −Vₛᵤₛ through the control switch SW10 and the control switch SW4. When a ground voltage GND is used as the level voltage of the second electrode during the address period that is the period T₃ as shown in FIG. 8, the switching control of the second electrode board is not performed.

Finally, the period T₄ will be described. The period T₄ that is a sustain discharge period is complicated as compared with the periods T₁, T₂ and T₃. First, after the period T₃ that is an address period is finished, the control switch SW1 is on and the control switch SW4 is off in the energy recovery circuit. In the scan device, the control switch SW9 is off and the control switch SW10 is on. As such, if the control switch SW1 is on, the voltage applied to the negative high-voltage terminal of the scan device increases smoothly by means of the LC resonance induced by an inductor LR of the energy recovery circuit and a capacitor component of the panel CP. Subsequently, when the control switch SW3 is on to apply the positive discharge voltage Vₛᵤₛ, discharge is performed in the discharge cell. At this time, the control switch SW1 may be off or on. Then, after a certain time is maintained to generate a sufficient discharge, the control switches SW1 and SW3 are off, and the control switch SW2 is on so as to recover energy supplied to the panel. Therefore, the voltage is changed into the negative sustain discharge voltage −Vₛᵤₛ by means of the LC resonance induced by the inductor LR and recovery capacitor CR of the energy recovery circuit. Thereafter, if the control switch SW4 applying the negative sustain discharge voltage is on, discharge is performed in the discharge cell so that the first electrode of the discharge cell has negative charge. In this case, the control switch SW2 may also be off or on. In all the periods where the switching of the first electrode board is performed to apply a sustain discharge voltage, the control switch SW9 of the second electrode board remains on so as to apply a voltage of 0 V.

The current flow in the period T₄ will be described with reference to FIG. 14. Specifically, when the control switch SW 1 of the first electrode board is on, current Iₛᵤₛ₁ is applied from the capacitor CR to the first electrode of the panel through the control switch SW1, the diode D1, the inductor LR and the control switch SW10. In the sustain discharge period in which the control switch SW3 is on, current Iₛᵤₛ₂ is applied from the positive sustain discharge voltage Vₛᵤₛ to the first electrode of the panel through the control switch SW3 and the control switch SW10. On the other hand, when the control switch SW2 is on, current Iₛᵤₛ₃ flows from the panel CP to the capacitor CR through the control switch SW10, the inductor LR, the diode D2 and the control switch SW2. When the control switch SW4 discharged with the negative sustain discharge voltage is on, current Iₛᵤₛ₄ flows from the panel CP to the negative sustain discharge voltage through the control switch SW10 and the control switch SW4.

The operation of the PDP driving circuit in the periods T₁ to T₄ has been described. After the period T₄ is finished, the voltage waveform of the second electrode is connected to a reset waveform of the next subfield. Two methods may be used as a method for raising the switching driving voltage described in the period T₁. A first method is a method in which a voltage is increased up to a predetermined level by allowing the control switch SW1 of the energy recovery circuit to be on, and the control switch SW is then off. A second method is a method in which a driving circuit having two slopes is implemented using the control switches SW5 as described above.

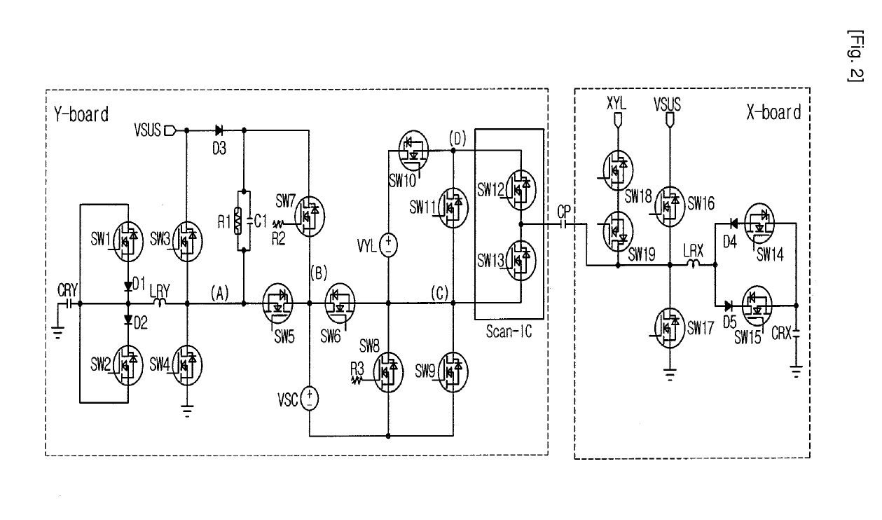

The PDP driving circuit according to the embodiment of the present invention has a simpler circuit configuration than that of the conventional PDP driving circuit. In FIG. 2, the two control switches SW5 and SW6 are used while a sustain discharge voltage is applied to the scan electrode. However, in the present invention, the corresponding switches are not used, and the sustain discharge voltage can be more stably supplied to the panel. Further, a DC/DC circuit generating the scan voltage −V_{sc} is not required.

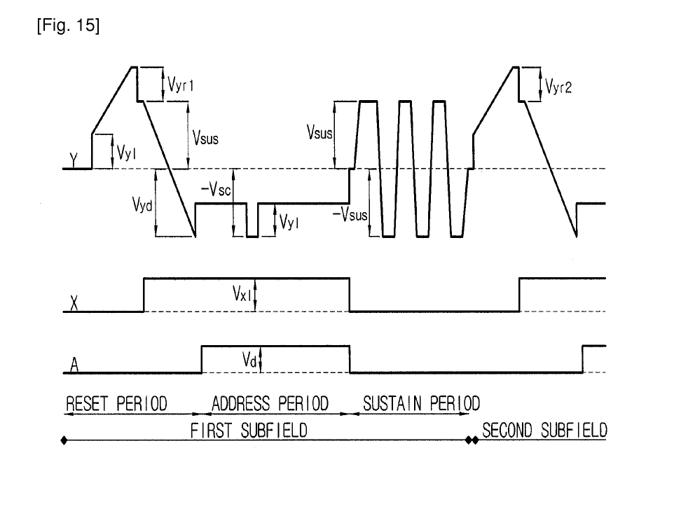

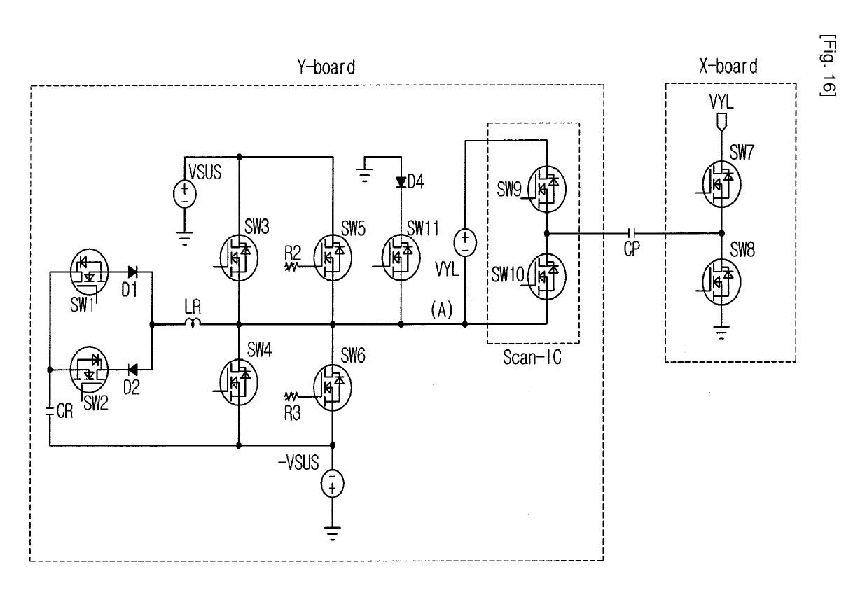

Meanwhile, an application of a ground voltage GND to the second electrode waveform will be described as another embodiment of the present invention. FIG. 15 is a waveform diagram showing a PDP driving waveform according to another embodiment of the present invention. FIG. 16 is a circuit diagram of a PDP driving circuit for realizing the driving waveform of FIG. 15 according to another embodiment of the present invention.

At the time when a ramp-up period starts after a negative sustain discharge voltage −Vₛᵤₛ is applied, a control method is not used, in which the ramp-up control switch is immediately on, or the ramp-up voltage has two slopes using the control switch SW1 of the energy recovery circuit. However, as shown in FIG. 15, the output voltage of the first electrode board is first shifted into a ground state GND, and the period T₁ then starts. At this time, before the output voltage is shifted into the ground state GND, the control switch SW1 of the energy recovery circuit may be on so as to rise from a negative sustain discharge voltage to a predetermined voltage. Accordingly, overshoot noise can be reduced.

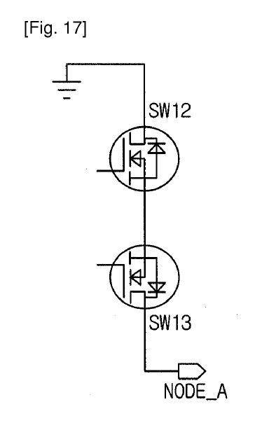

The driving circuit for realizing the PDP driving waveform of the FIG. 15 will be described. As shown in FIG. 16, a control switch SW 11 is provided as a control switch for shifting a voltage into a ground state GND. The control switch SW11 is connected in series to a diode D4 for preventing reverse bias, and then connected to a ground GND. If the diode D4 is not used, a large current flows into a terminal of the ground GND through the control switch SW11 when a positive sustain voltage is outputted through the first electrode. For this reason, the diode D4 is required. It will be apparent that two control switches SW12 and SW13 may be disposed without the diode D4 as shown in FIG. 17, thereby preventing the flow of a large current.

The invention has been described in detail with reference to exapmle embodiments thereof. However, it will be appreciated by those skilled in the art that changes may be made in these embodiments without departing from the principles and spirit of the invention, the scope of which is defined in the accompanying claims and their equivalents.

### INDUSTRIAL APPLICABILITY

A PDP driving circuit and a driving method thereof according to the present invention have advantages as follows.

The PDP driving circuit according to the present invention has a simpler circuit configuration than the conventional PDP driving circuit. In the PDP driving circuit according to the present invention, a sustain discharge voltage can be more stably supplied to a panel than in the conventional PDP driving circuit. In the conventional PDP driving circuit of FIG. 2, two control switches SW5 and SW6 are used while the sustain discharge voltage is applied to scan electrodes. However, in the present invention, the corresponding control switches are not required. Therefore, the entire power consumption and heat generation of the driving circuit can be decreased, and the sustain discharge voltage can be stably supplied to the panel. Further, since a DC/DC circuit generating a scan voltage −V_{sc} is not required, cost of manufacturing the driving circuit can be saved.

1. A driving method of a plasma display panel (PDP), comprising a first electrode applying a ramp-up voltage, a ramp-down voltage, a scan voltage, a level voltage of the first electrode and a sustain discharge voltage; a second electrode applying a ground voltage GND and a level voltage of a second electrode; and a third electrode applying a data voltage for selecting discharge cells in an address period, the driving method using a driving waveform divided into a reset period, an address period and a sustain period,
wherein, in the sustain period, positive and negative sustain discharge voltages are alternately applied to the first electrode and the ground voltage GND is applied to the second electrode.

2. The driving method as set for in claim 1, wherein the maximum amplitude of a ramp voltage of the first electrode in a ramp-up period of the reset period does not exceed the sum of the positive sustain discharge voltage and the level voltage of the first electrode.

3. The driving method as set forth in claim 1, wherein, in the ramp-up period, the maximum amplitude of the ramp voltage applied to the first electrode is different for each subfield.

4. The driving method as set forth in claim 1, wherein, in the ramp-up period, the voltage applied to the first electrode does not contain a level voltage component but contains only a waveform with a slope using the positive sustain discharge voltage.

5. The driving method as set forth in claim 1, wherein, in the ramp-up period, the ramp voltage rising with a slope applied to the first electrode has two different slopes.

6. The driving method as set forth in claim 5, wherein a first slope is steeper than a second slope.

7. The driving method as set forth in claim 1, wherein, a negative sustain discharge voltage is applied to the first electrode before the ramp-up period starts.

8. The driving method as set forth in claim 1, wherein, in a ramp-down period of the reset period, the ramp voltage falling with a slope has two different slopes.

9. The driving method as set forth in claim 8, wherein a first slope is steeper than a second slope.

10. The driving method as set forth in claim 1, wherein the voltage applied to the first electrode at the end time of the reset period is identical to or higher than the negative sustain discharge voltage.

11. The driving method as set forth in claim 1, wherein, in the ramp-down period, the ground voltage GND is applied to the second electrode.

12. The driving method as set forth in claim 11, wherein, in the address period, the voltage applied to the second electrode is a ground voltage GND.

13. The driving method as set forth in claim 1, wherein the absolute values of the positive and negative sustain discharge voltages applied to the first electrodes are identical to each other.

14. The driving method as set forth in claim 1, wherein a voltage of 0 V is not used as the voltage applied to the first electrode.

15. A driving circuit of a PDP, controlling a driving waveform divided into a reset period, an address period and a sustain period, the driving circuit controlling a ramp-up voltage, a ramp-down voltage, a scan pulse and a sustain discharge voltage, applied to a first electrode; a level voltage and a ground voltage, applied to a second electrode; and a data voltage applied to a third electrode, wherein:
the driving circuit has a combination of a first electrode board controlling the voltage applied to the first electrode and a second electrode board controlling the voltage applied to the second electrode, and the first electrode board comprises:
a control switch SW3 supplying a positive sustain discharge voltage +Vₛᵤₛ;
a control switch SW4 supplying a negative sustain discharge voltage −Vₛᵤₛ;
a control switch SW5 connected to the positive sustain discharge voltage to generate a ramp-up waveform rising with a slope; and a control switch SW6 connected to the negative sustain discharge voltage to generate a ramp-down waveform falling with a slope.

16. The driving circuit as set forth in claim 15, wherein the first electrode board further comprises:
a control switch SW2 recovering energy from the first electrode board;
a control switch SW1 supplying the recovered energy; and
a capacitor CR storing the energy recovered by the control switch SW2, wherein a negative terminal of the capacitor CR for energy recovery is connected to the negative sustain discharge voltage.

17. The driving circuit as set forth in claim 15, wherein the first electrode board further comprises:
a control switch SW2 recovering energy from the first electrode board; and
a control switch SW1 supplying the recovered energy, wherein a contact point between the control switches SW1 and SW2 is connected to the ground voltage.

18. The driving circuit as set forth in claim 15, further comprising a scan device having control switches SW9 and SW10 controlling a high-voltage output of the first electrode board, wherein a positive high-voltage input terminal of the scan device is connected to a positive terminal of a level voltage V_{yl} of the first electrode, and a negative high-voltage input terminal of the scan device is connected to a negative terminal of the level voltage of the first electrode.

19. The driving circuit as set forth in claim 18, wherein a diode D3 and a capacitor C1 are further provided between the level voltage V_{yl} of the first electrode and the positive high-voltage input terminal of the scan device, wherein the negative terminal of the level voltage is connected to the negative sustain discharge voltage −Vₛᵤₛ.

20. The driving circuit as set forth in claim 15, wherein the second electrode board comprises:
a control switch SW7 applying a level voltage Vₓₗ of the second electrode; and a control switch SW8 applying the ground voltage.

21. The driving circuit as set forth in claim 15, wherein no control switch is used in the second electrode board so as to apply only the ground voltage GND.

22. The driving circuit as set forth in claim 15, further comprising:
a control switch SW11 applying the ground voltage GND to the first electrode in a period preceding the ramp-up period; and
a diode D4 connected in series to the control switch SW11, wherein the diode D4 is connected to the ground voltage.

23. The driving circuit as set forth in claim 15, further comprising two switches SW12 and SW13 connected in series to apply the ground voltage GND to the first electrode in the period preceding the ramp-up period, wherein the control switch SW12 is connected to the ground voltage.
